(19) United States
(12) Patent Application Publication
(10) Pub. No.: US 2017/0300864 A1
(43) Pub. Date: Oct. 19, 2017

(54) ATTRIBUTE MATCHING

(71) Applicant: tilr corporation, New York City, NY (US)

(72) Inventors: Luke Vigeant, New York City, NY (US); Summer Crenshaw, New York City, NY (US); Carisa Miklusak, New York City, NY (US); Solomon Pillersdorf, New York City, NY (US); Stephen Shefsky, New York City, NY (US)

(21) Appl. No.: 15/491,428

(22) Filed: Apr. 19, 2017

Related U.S. Application Data
(60) Provisional application No. 62/324,839, filed on Apr. 19, 2016.

(51) Int. Cl. G06Q 10/10; G06F 17/30

(52) U.S. Cl. CPC G06Q 10/1053; G06F 17/30477

(57) ABSTRACT

A method includes receiving a request associated with a first attribute, the request representative of an opportunity for employment, the attribute representative of a qualification associated with the opportunity for employment; querying a database to identify a record including a second attribute satisfying the first attribute associated with the request, the second attribute included in the record having been determined based on other information in the record; and serving, to a computing device operated by a user associated with the identified record, a network resource providing the user with access to information about the request.

### CLAIM OF PRIORITY

This application claims priority to U.S. Patent Application Ser. No. 62/324,839, filed on Apr. 19, 2016, the entire contents of which are incorporated here by reference.

### BACKGROUND

A user of a computing device can request a network resource to obtain information about an opportunity, such as an employment opportunity, for which he or she believes they are qualified. The network resource can be served to the computing device to provide the user with information and to enable to user to take actions to pursue the opportunity.

### SUMMARY

In a general aspect, a method includes receiving a request associated with a first attribute, the request representative of an opportunity for employment, the attribute representative of a qualification associated with the opportunity for employment; querying a database to identify a record including a second attribute satisfying the first attribute associated with the request, the second attribute included in the record having been determined based on other information in the record; and serving, to a computing device operated by a user associated with the identified record, a network resource providing the user with access to information about the request.

Embodiments can include one or more of the following features.

The method includes updating a table to include a representation of the identified record.

The method includes updating a data storage to include an identifier of the identified record.

The method includes updating a data storage to include a reference to the identified record.

The second attribute is the same as the first attribute.

The second attribute is different from the first attribute, and in which identifying the record includes querying an attribute database to determine that the second attribute is related to the first attribute.

The request is associated with an opportunity record, in which the first attribute associated with the request is included in the opportunity record.

The first attribute is associated with a first level, and in which querying the database includes querying the database to identify a record in which a second level associated with the second attribute matches the first level associated with the first attribute.

The request is associated with multiple first attributes, each first attribute having a respective weighting factor.

Querying the database to identify a record includes identifying a record having second attributes satisfying the first attributes subject to the respective weighting factors of the first attributes. The method includes determining a score for the record based on the second attributes and respective weighting factors, and in which identifying the record comprising determining that the record has a score higher than a threshold score. The method includes determining a score for each of multiple records based on the second attributes and respective weighting factors of each of the multiple records, and in which identifying a record comprising identifying the record having the highest score.

The method includes querying the database to identify a second record, the second record not having a second attribute that satisfies the first attribute; and serving, to a computing device operated by a user associated with the identified record, a network resource providing the user with access to information to obtain the second attribute that satisfies the first attribute.

First attribute comprises one or more of a skill attribute, a certification attribute, and a tool attribute.

The second attribute included in the record having been determined based on a job title included in the record.

In a general aspect, a non-transitory computer readable medium stores instructions for causing a computing system to receive a request associated with one or more attributes, the request representative of an opportunity for employment, each attribute representative of a qualification associated with the opportunity for employment; query a database to identify a record including the one or more attributes associated with the request, the one or more attributes included in the record having been determined based on other information in the record; and serve, to a computing device operated by a user associated with the identified record, a network resource providing the user with access to information about the request.

Embodiments can include one or more of the following features.

The instructions cause the computing system to update a table to include a representation of the identified record.

The instructions cause the computing system to update a data storage to include an identifier of the identified record.

The instructions cause the computing system to update a data storage to include a reference to the identified record.

The second attribute is the same as the first attribute.

The second attribute is different from the first attribute, and in which identifying the record includes querying an attribute database to determine that the second attribute is related to the first attribute.

The request is associated with an opportunity record, in which the first attribute associated with the request is included in the opportunity record.

The first attribute is associated with a first level, and in which querying the database includes querying the database to identify a record in which a second level associated with the second attribute matches the first level associated with the first attribute.

The request is associated with multiple first attributes, each first attribute having a respective weighting factor.

Querying the database to identify a record includes identifying a record having second attributes satisfying the first attributes subject to the respective weighting factors of the first attributes. The instructions cause the computing system to determine a score for the record based on the second attributes and respective weighting factors, and in which identifying the record comprising determining that the record has a score higher than a threshold score. The instructions cause the computing system to determine a score for each of multiple records based on the second attributes and respective weighting factors of each of the multiple records, and in which identifying a record comprising identifying the record having the highest score.

The instructions cause the computing system to query the database to identify a second record, the second record not having a second attribute that satisfies the first attribute; and serve, to a computing device operated by a user associated with the identified record, a network resource providing the user with access to information to obtain the second attribute that satisfies the first attribute.

The first attribute comprises one or more of a skill attribute, a certification attribute, and a tool attribute.

The second attribute included in the record having been determined based on a job title included in the record.

### BRIEF DESCRIPTION OF DRAWINGS

FIG. 1 is a system diagram.

FIG. 2 is a diagram of a database.

FIG. 3 is a flow chart.

FIGS. 4-10 are screenshots of a user interface.

FIGS. 11-17 are screenshots of a user interface.

### DETAILED DESCRIPTION

We describe here an approach to providing network resources, e.g., web pages, pages of a mobile application, etc., to a user based on attributes associated with the user. A system receives a request associated with one or more attributes. Responsive to the request, the system queries a database storing user records, each user record associated with a corresponding user, to identify a user record having attributes that match the attributes associated with the received request. The system provides network resources to a user associated with the identified user record, the network resources providing the user with access to information about the request. For example, the network resources provided to the user can provide the user with access to information about the request.

In some examples, the request can be a request for a user possessing one or more qualification attributes associated with an available opportunity for employment, such as skill, tool, or certification attributes associated with the opportunity. The database storing user records can be queried to identify a user record associated with a user possessing the one or more qualification attributes indicated by the request. Network resources provided to the user associated with the identified user record can provide the user with access to information about the opportunity.

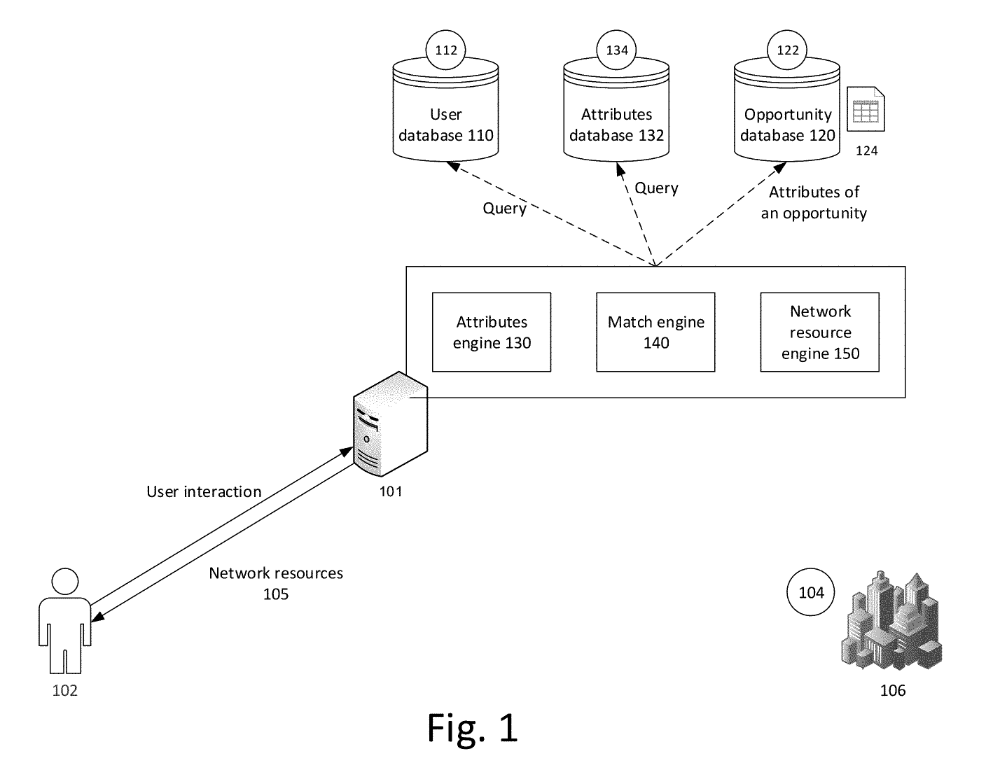

Referring to FIG. 1, a system 100 implemented by a server 101 enables a user 102 of the system 100 to be provided with network resources 105 associated with an opportunity 104 offered by an employer 106. An opportunity 104, for example, is an opportunity for employment with the employer 106. Each opportunity 104 represents an employment position (e.g., Barista, Administrative Assistant, Warehouse Clerk, or another position) having a specified schedule. An opportunity 104 can be a one-time occurrence (e.g., a Mail Clerk for Apr. 12, 2016, from 9 am-5 pm), a short-term recurring position (e.g., a Bartender from 6 pm-2 am from Apr. 1, 2016 to Apr. 8, 2016), a long-term recurring position (e.g., a Lifeguard from 10 am-6 pm from Jun. 1, 2016 to Sep. 1, 2016), or a permanent position (e.g., a Legal Secretary from 8 am-5 pm, Monday through Friday, beginning on May 2, 2016).

Each user 102 of the system 100 possesses a set of qualification attributes, such as skill, tool, and/or certification attributes the user has accumulated through education or previous or current employment experience. Each opportunity 104 offered through the system 100 is associated with a set of qualification attributes, such as skill, tool, and/or certification attributes, the employer 106 offering the opportunity expects that a person qualified for the opportunity will possess. The system 100 can automatically identify one or more users 102 that are qualified for a particular opportunity 104 based on a match between the qualification attributes (e.g., skill, certification, and/or tool attributes) possessed by each user 102 and the qualification attributes associated with the particular opportunity 104. The server 101 can serve network resources 105 associated with the particular opportunity 104 to one or more of the users 102 identified as qualified for the opportunity.

The server 101 can access a user database 110 that stores a user record 112 for each user 102. The user record 112 for a user 102 can be established upon enrollment of the user 102 with the system 100. The user record 112 for a particular user 102 can include biographical information about the user 102 (e.g., the user's name, address, e-mail address, phone number, or other biographical information), information about the user's work history, information about the user's educational history, skills possessed by the user, a level of proficiency for each skill, certifications possessed by the user, tools at which the user is proficient, a level of proficiency for each tool, or other information. Information about the user's work history can include titles of jobs previously or currently held by the user, names of previous or current employers, or other information. Information about the user's educational history can include degrees earned by the user, degrees partially completed by the user, coursework completed or in progress, professional certifications, or other information.

In some examples, the user record 112 for a user 102 can include attributes indicative of user preferences, such as location attributes (e.g., indicative of a geographical area the user prefers for his opportunities, a geographical area outside of which the user will not consider opportunities, or other location preferences), schedule attributes (e.g., indicative of preferred days or times for opportunities, days or times the user is unavailable for opportunities, or other schedule preferences), or other attributes. In some examples, the user record 112 can include information about opportunities previously completed by the user, such as the user's rating of a previous opportunity or an employer's rating of a user following completion of a previous opportunity (discussed below).

Some information stored in the user record 112 for a particular user 102 can be entered by the user. For instance, the user 102 can enter biographical information, work history or educational history information, user preferences, or other information. Some information stored in the user record 112 can be determined by the system 100, in conjunction with input from the user. For instance, an attributes engine 130 can identify the qualification attributes (e.g., skill, certification, and/or tool attributes) possessed by the user and/or a level of proficiency associated with each qualification attribute (e.g., the level of proficiency for each skill or tool or the level of a multi-level certification achieved by the user) based on information about the user, such as based on the user's work history or educational history.

An attributes engine 130 implemented by the server 101 can identify one or more qualification attributes that may be possessed by a particular user 102 based on information about the user. For instance, a user may provide information about a previous job, including the title of the position. An attributes database 132 includes job title records 134, each of which includes a job title and an indication of any related job titles (e.g., a pointer to a job title record of each related job title). The attributes engine 130 queries the attributes database 132 to identify one or more job title records 134 that include job titles that are similar or related to the title entered by the user. Each job title record 134 also includes a list of qualification attributes associated with the job title or a reference (e.g., a pointer) to each qualification attribute associated with the job title. The attributes engine 130 identifies a list of the qualification attributes associated with each of the identified job title records 134. The identified qualification attributes are presented to the user via a network resource rendered as a web page (e.g., based on HTML code), a page of a mobile application, or another rendering of the network resource. The user can interact with the network resource to indicate which of the presented qualification attributes (e.g., skills, certifications, or tools) he or she possesses, and in some cases a level of proficiency associated with each qualification attribute. Based on the user interaction with the network resource, qualification attributes (and, in some cases, a level of proficiency associated with each qualification attribute) are stored in the user record 112. In some examples, the network resources interacted with to navigate to the presented qualification attributes can also be stored in the user record 112.

The qualification attributes can be skill attributes indicative of skills possessed by the user. Skills are capabilities that the user has acquired through past employment, education, and/or other experiences. The qualification attributes can be certification attributes indicative of certifications possessed by the user. A certification is achieved by a user who completes a defined set of activities to achieve the certification, such as classes, trainings, or exams. Certifications can be issued by governmental bodies, trade or professional organizations, employers, or other entities. The qualification attributes can be tool attributes indicative of tools with which the user is proficient. Tools can be physical tools, such as a forklift, an arc welder, or an espresso machine; or software tools, such as word processing or billing software or programming languages.

In an example, if a user enters the title “Admin Assistant,” the attributes engine 130 may query the attributes database 132 to identify the following similar or related job titles: Administrative Assistant, Executive Assistant, Secretary, Office Manager. A list of the qualification attributes associated with one or more of the job titles Administrative Assistant, Executive Assistant, Secretary and Office Manager is presented to the user. The user can then select the skills and certifications he possesses and the tools at which he is proficient from the presented list of qualification attributes, and in some cases can indicate his level of proficiency for each selected skill, certification, and/or tool. The selected skills, certifications, and/or tools are stored as qualification attributes in the user record 112.

Example skills for the job titles Administrative Assistant, Executive Assistant, Secretary, and Office Manager can include Word Processing, Scheduling, Business Correspondence, and Editing, among others. Example certifications for these job titles can include the Certified Professional Secretary and the Certified Administrative Professional certifications, among others. Example tools for these job titles can include Microsoft Word, Microsoft Excel, and Quickbooks, among others.

In some examples, two or more skill attributes can be linked in the attributes database 132 as substantially equivalent skills, such that if a user selects one of the linked skill attributes, the other one or more linked skill attributes are also automatically selected for the user. For instance, if the user selects the skill Appointment Scheduling, the linked skills Calendar Management and Schedule Management can also be automatically selected for the user.

In some examples, tool attributes are children of skill attributes, such that if a user possesses a tool attribute, the user always also possesses the skill attribute from which that tool attribute depends. For instance, if the user possesses the Microsoft Word tool attribute, the user will also possess the Word Processing skill attribute.

In some examples, a certification attribute is associated with one or more skill attributes and/or one or more tool attributes, such that if a user possesses a certification attribute, the user will also possess the associated skill attributes and/or tool attributes. For instance, the Certified Administrative Professional certification attribute can be associated with the skill attributes Business Writing and Records Management, among others.

In some examples, the attributes database 132 can include education records 136, each of which includes a type of degree (e.g., associate's degree, bachelor's degree or another type of degree) and a field of study (e.g., business, chemistry, English, or another field of study). In some examples, the attributes engine 130 can query the attributes database 132 to identify one or more education records 136 that are similar or related to items in the user's educational history. Each education record 136 also includes a list of qualification attributes associated with the type of degree and field of study or a reference (e.g., a pointer) to each qualification attribute. The qualification attributes associated with each of the identified education records 136 are presented to the user via a network resource rendered as a web page, a page of a mobile application, or another rendering of the network resource. The user can interact with the network resource to indicate which of the presented qualification attributes (e.g., skill, certification, or tool attributes) he possesses, and in some cases a level associated with each qualification attribute. Based on the user interaction with the network resource, qualification attributes (and in some cases, a level associated with each qualification attribute) are stored in the user record 112.

In some examples, a user can acquire new qualification attributes through activities undertaken through the system 100, such as through completion of opportunities or education offered through the system 100. The attributes engine 130 can automatically update a user's user record 112 to reflect the qualification attributes acquired through the system.

The system 100 includes an opportunity database 120 that stores an opportunity record 122 for each available opportunity 104 in the system 100. The opportunity record 122 for a particular opportunity 104 can include the title of the position represented by the opportunity, information about the employer 106 offering the opportunity (e.g., the name of the employer, contact information for the employer, or other information), qualification attributes (e.g., skill, certification, or tool attributes) associated with the opportunity, a level of proficiency associated with each qualification attribute, a location attribute for the opportunity, a schedule attribute for the opportunity, a description of the opportunity (e.g., including text, images, video, or other types of data), or other information.

Some information stored in the opportunity record 122 for a particular opportunity 104 offered by an employer 106 can be entered by or on behalf of the employer, such as the title of the position, information about the employer, a location of the opportunity, a schedule for the opportunity, a description of the opportunity, or other information. Some information stored in the opportunity record 122 can be determined by the system 100, in conjunction with input from or on behalf of the employer. For instance, the attributes engine 130 can identify qualification attributes to be associated with the opportunity 104 and/or a level of proficiency associated with each qualification attribute based on information about the opportunity, such as based on the title of the position, as described above.

A match engine 140 identifies one or more users 102 as qualified for a particular opportunity 104 based on a match between the qualification attributes possessed by the users 102 and the qualification attributes associated with the opportunity 104. For instance, to identify users for a particular opportunity 104, the match engine 140 can query the user database 110 to identify those user records (e.g., record 112) having all of the qualification attributes included in the opportunity record 122 for the particular opportunity 104. In some examples, the opportunity record 122 for the particular opportunity includes a level of proficiency associated with one or more of the qualification attributes, and the match engine 140 can query the user database 110 to identify those user records (e.g., record 112) having all of the qualification attributes included in the opportunity record 122 and having the indicated level for each of one or more of the qualification attributes. We sometimes refer to user records (e.g., record 112) that have all of the qualification attributes included in the opportunity record 122 for a particular opportunity and having the indicated level of proficiency for each of the one or more qualification attributes as user records that are matched with the opportunity record.

In some examples, user records (e.g., record 112) identified as matched with an opportunity record are stored in a match table 124 associated with the opportunity record. In some examples, user records identified as matched with an opportunity record can be tracked in another way, such as through a document storing identifiers of the user records or references (e.g., pointers) to the user records.

In some examples, the match engine 140 can identify user records (e.g., record 112) that include all of the qualification attributes included in the opportunity record for a particular opportunity 104 and at the designated level as matches for the opportunity. In addition, the match engine 140 can identify one or more user records as imperfect matches for the opportunity. A user record (e.g., record 112) that is an imperfect match with an opportunity is a user record does not include all of the qualification attributes included in the opportunity record for the opportunity 104, or not at the designated level of proficiency, but is otherwise substantially similar. In an example, a user record that is an imperfect match with an opportunity may include all but one of the qualification attributes included in the opportunity record for the opportunity. In an example, a user record that is an imperfect match with an opportunity may include all of the qualification attributes included in the opportunity record for the opportunity, but may have at least one qualification attribute at a level of proficiency different from that designated in the opportunity record. User records that are imperfect matches for an opportunity can be flagged for review by an operator, such as a human resources professional, who can determine whether the user record may anyway be regarded as a match for the opportunity.

In some examples, the opportunity record 122 can include one or more rules that can be implemented to govern how a user record 112 is identified as a match for the opportunity 112 represented by the opportunity record 122. For instance, each of one or more qualification attributes associated with an opportunity is assigned a weighting factor to indicate its relative importance as compared with other qualification attributes associated with the opportunity. A user record (e.g., record 112) can be identified as a match for an opportunity 104 subject to the qualification attributes and associated weighting factors for the opportunity. In an example of a rule, if a user record is missing a highly weighted qualification attribute associated with an opportunity, the user record may not be identified as a match, but a user record missing a lower weighted qualification attribute may still be identified as a match. In an example of a rule, a score can be determined for a record based on the qualification attributes and associated weighting factors, and the record can be identified as a match if the score exceeds a threshold score. In an example of a rule, a score can be determined for each of multiple records based on the qualification attributes and associated weighting factors, and the record having the highest score can be identified as a match.

In some examples, the match engine 140 can identify one or more users for a particular opportunity 104 based on attributes other than qualification attributes (e.g., skill, tool, and/or certification attributes). For instance, the match engine 140 can query the user database 110 to identify those user records (e.g., record 112) having location or schedule attributes that are consistent with location or schedule attributes for the opportunity. In some examples, to identify users for a particular opportunity 104, the match engine 140 first queries the user database 110 to identify one or more user records based on location and/or schedule attributes, and then identifies a subset of those user records having qualification attributes that are matched with the opportunity record 122 for the opportunity 104. In some examples, the match engine 140 first queries the user database 110 to identify one or more user records (e.g., record 112) having qualification attributes that are matched with the opportunity record 122 for a particular opportunity, and then identifies a subset of those user records based on location and/or schedule attributes.

A network resource engine 150 renders a network resource, such as a web page or a page of a mobile application, for presentation to one or more of the users 102 whose user record (e.g., record 112) was identified by the match engine 130. The network resource can include information about the opportunity 104. Through the network resource, the one or more users 102 are prompted to respond to accept or decline the opportunity 104. When an acceptance is received from a user 102, the user record 112 for the user 102 is updated to reflect that the user 102 is assigned to the opportunity 104. If a user declines the opportunity, the opportunity can be presented to another user.

The approach of the system 100, in which users are identified as qualified for a particular opportunity based on matching of qualification attributes between the user's user record 112 and the opportunity record 122 for the opportunity, enables qualified users to be offered opportunities even if the opportunity differs from previous jobs the user has held. For instance, a qualified user may be offered an opportunity for a Wait Staff position even if the user has not previously worked as a waiter. Offering opportunities to qualified users enables efficient use of the labor pool of users in the system and helps to provide employment to users and to fill open positions with employers.

In some examples, the match engine 140 can determine that a particular user would be able to match with an opportunity if the user possessed one or more additional qualification attributes or if the user increased his level of proficiency for one or more of his qualification attributes. The system can suggest to the user that he acquire the missing qualification attribute(s) or increase the level associated with one or more of the qualification attributes he already possesses. For instance, the system can suggest that the user acquire certain skill, certification, or tool attributes or increase his level of proficiency for one or more of his skill or tool attributes. In some examples, educational opportunities can be provided through the system in order to assist users in acquiring additional skill, certification, and/or tool attributes, or in increasing their level of proficiency in one or more of their skill or tool attributes. This approach can help users to become qualified for better opportunities, such as opportunities with higher pay, more responsibility, or other features.

In some examples, educational opportunities (e.g., training courses) can be provided to users through the system 100 to enable the users to obtain additional qualification attributes or to increase their level of proficiency for each of one or more qualification attributes. In some examples, the system 100 can host the educational opportunities, e.g., by serving network resources including live or previously recorded training courses or interactive training modules. In some examples, the system 100 can provide links to external network resources with appropriate educational opportunities.

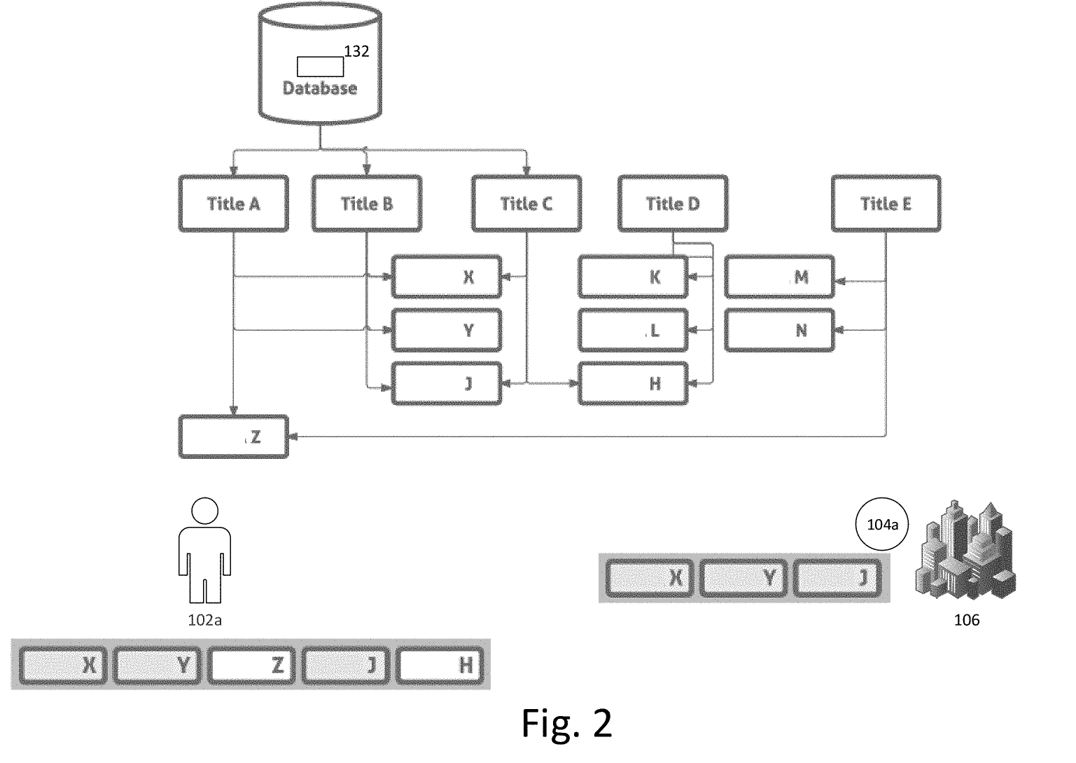

Referring to FIG. 2, in a specific example, the attributes database 132 includes job title records 134 for five job titles: Title A, Title B, Title C, Title D, and Title E. Each job title record 134 includes references to the qualification attributes associated with the job title of the record. For instance, the job Title A is associated with qualification attributes X, Y, and Z. The job Title B is associated with qualification attributes X, Y, and J. The job Title C is associated with qualification attributes X, J, and H. In a specific example, Titles A, B, and C may be Custodian, Housecleaner, and Gardener, respectively. The qualification attribute X may be “Manual labor,” the qualification attribute Y may be “Cleaning,” the qualification attribute Z may be “Facilities management,” the qualification attribute J may be “Managing client expectations,” and the qualification attribute H may be “Working outdoors.”

In this example, a user 102a has worked in a Title A role (e.g., Custodian) and a Title C role (e.g., Gardener) and has indicated (e.g., during an enrollment process) that he has acquired all of the qualification attributes associated with these two roles. The worker 102a thus possesses qualification attributes X (Manual labor), Y (Cleaning), Z (Facilities management), J (Managing client expectations), and H (Working outdoors). Although the user has never worked in a Title B role (e.g., Housecleaner), the match engine 140 identifies the user 102a as qualified for an opportunity 104a in a Title B role because the user 102a possesses all of the qualification attributes associated with the Title B role.

In some examples, the matching of skill attributes can be based on linked skill attributes. Skill attributes can be linked in the attribute database 132 if the two skills are substantially equivalent. If the user 102a does not possess a specific skill attribute associated with the opportunity 104a but does possess a different skill attribute that is linked to that specific skill attribute, the user 102a may be identified as qualified for the opportunity 104a.

In the example of FIG. 2, the user 102a is identified as qualified for the opportunity 104a based on a comparison between the qualification attributes possessed by the user 102a and the qualification attributes associated with the opportunity 104a. In some examples, other criteria can be used in addition to matching of qualification attributes to determine whether the user 102a is to be offered the opportunity 104a. For instance, the user's location or schedule attributes or the user's previous experiences in opportunities offered through the system can be taken into account, e.g., as described above.

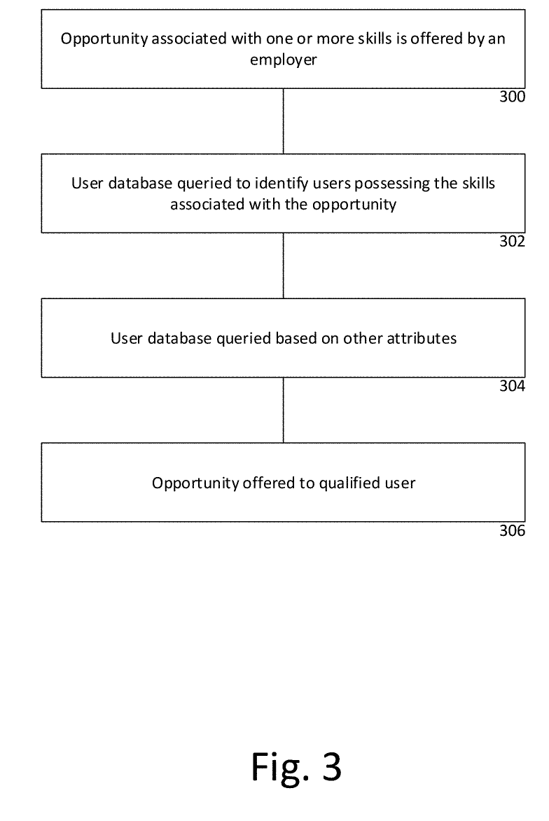

Referring to FIG. 3, in an example process, an opportunity associated with one or more qualification attributes is offered for a position with an employer (300). For instance, in the example of FIG. 2, the opportunity for a Title B position is associated with qualification attributes X, Y, and J. A query is undertaken to identify users in the system who possess the qualification attributes associated with the opportunity (302). For instance, the user database is queried to identify user records that include qualification attributes matching those associated with the opportunity. The user database can also be queried on other attributes (304), such as location or schedule attributes, to identify user records that are suited for the opportunity. The opportunity is offered to one or more of the users whose user record is identified by the query or queries (306).

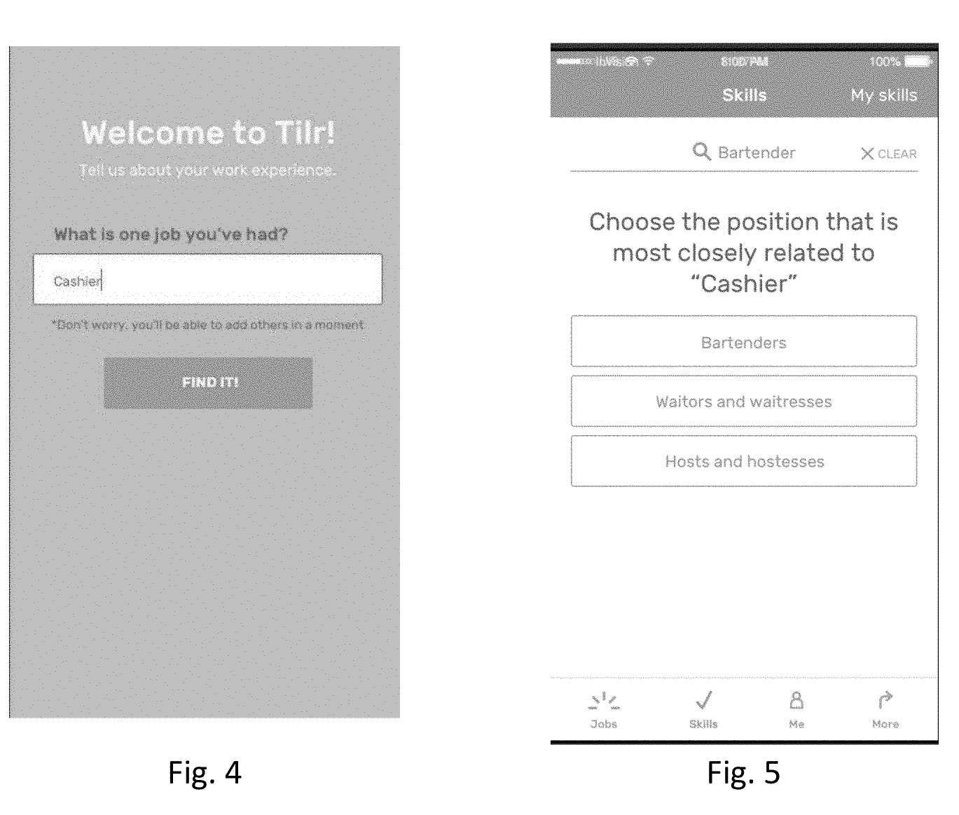

FIGS. 4-10 are screenshots of an example user interface through which a user can enter information into the system. The information can include biographical information about the user, information about the user's work history, information about the user's educational history, or other information. Through the user interface, the user can indicate the skills, certifications, and tools proficiencies he possesses, which are stored in the user's record as qualification attributes. In some cases, the user can also indicate a level of proficiency for each skill or tool. In the example of FIGS. 4-10, the user interface is the interface of a mobile computing device (e.g., a smartphone). In some examples, the user interface can be the display screen of another type of computing device, such as a desktop or laptop computer.

Referring to FIG. 4, in a view 400, the user can enter the title of a job he has held previously or current holds (e.g., Cashier). Referring to FIG. 5, a list of job titles that are similar or related to the title entered by the user are displayed in a view 500. For instance, the displayed job titles can be job titles that are similar or related to the entered job title, as determined by the skills engine. The user can select one or more of the displayed job titles to indicate that he has had experience with the selected job titles or to indicate that he expects that he possesses skills, certifications, or tool proficiencies associated with the selected job titles.

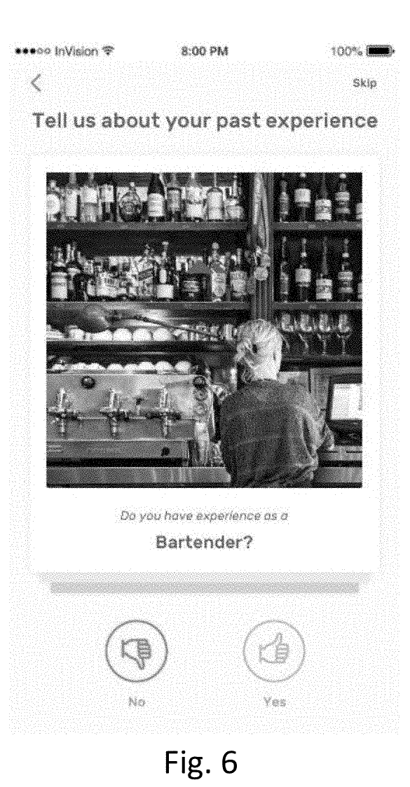

Referring to FIG. 6, in some examples, in addition to or instead of prompting the user to enter a job title (as in the view 400 of FIG. 4), one or more suggested job titles can be displayed to the user through a view 600. The user can select one or more of the suggested job titles to indicate that he has had experience with the selected job titles or to indicate that he expects that he possesses skills, certifications, or tool proficiencies associated with the selected job titles. The suggested job titles presented through the view 600 can be determined by the system based on an analysis of the user records, the opportunity records, or both. For instance, the suggested job titles can be job titles for which opportunities are currently available, job titles for which there have recently been a large or increasing number of opportunities, job titles associated with qualification attributes possessed by few users in the system, or other examples. In the example of FIG. 6, the suggested job titles are presented sequentially to the user. In some examples, a list of multiple suggested job titles can be presented to the user.

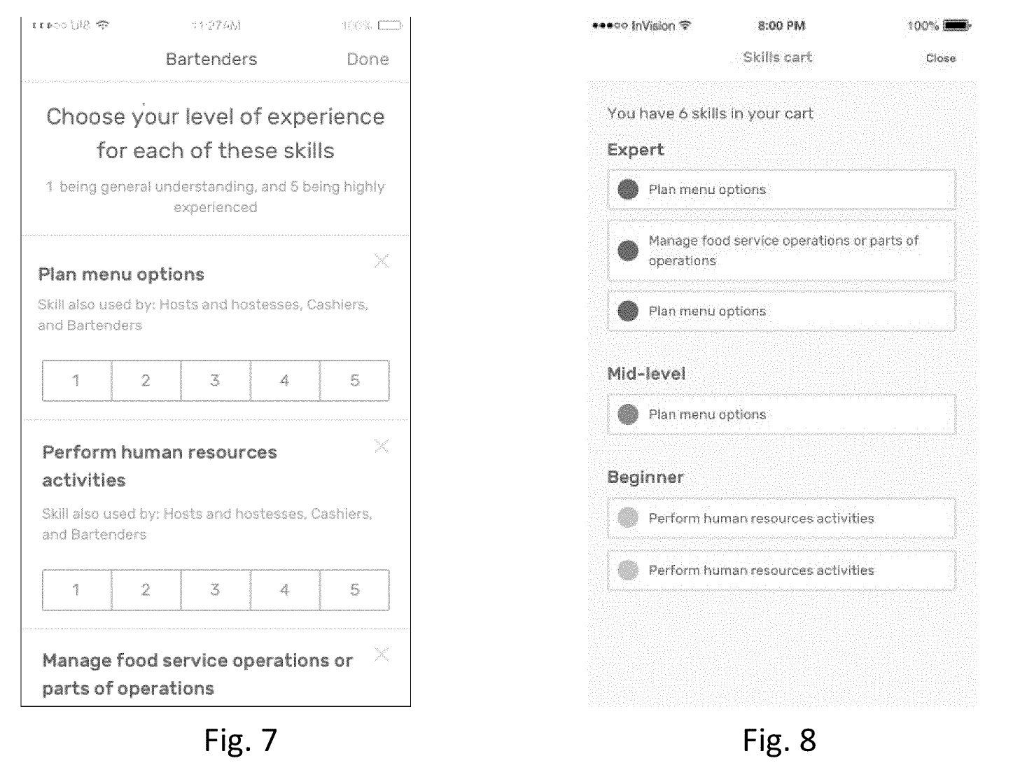

Referring to FIG. 7, in a view 700, the skill attributes associated with each job title selected by the user (e.g., through the view 500 or the view 600) are presented. The user can select the skills he possesses and his level of proficiency for each selected skill. In the example of FIG. 7, five levels of proficiency are available; in some examples, a different number of levels can be available. In some examples, the user only selects the skills he possesses and does not indicate a level of proficiency. In some examples, the level of proficiency for each skill is based on the user's qualitative self-assessment of his own abilities or experience. In some examples, the level of proficiency is defined based on a quantitative measure of the user's abilities or experience, such as based on a number of years of experience practicing a skill. Additional views (not shown) can prompt the user to select certifications he possesses and tools with which he is proficient.

Referring to FIG. 8, a view 800 displays the skills the user has indicated that he possesses and the level of proficiency for each skill. The view 800 can also display information about certifications and tools. The information shown in the view 800 will be used to match the user with an opportunity for which he is qualified. In some examples, the user undergoes a confirmation process, e.g., a telephone or in-person interview or a reference check, in order to confirm that the indicated skills, certifications, and tools, and associated levels of proficiency are accurate.

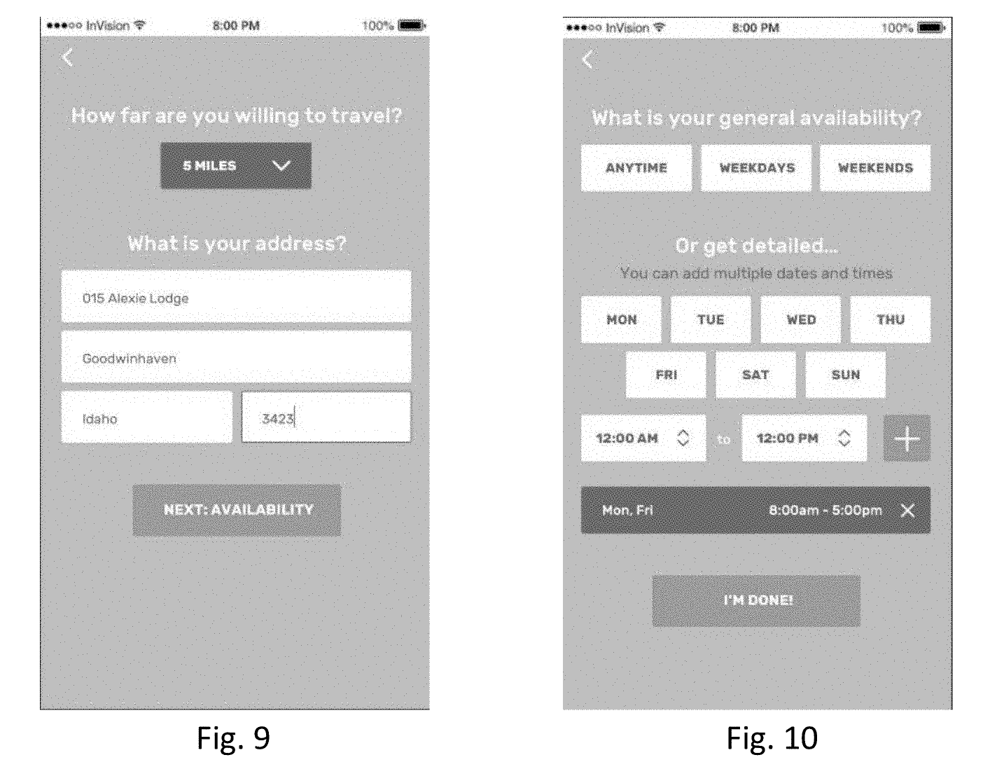

Referring to FIGS. 9 and 10, the user can input preferences, such as location preferences (through a view 900) or schedule preferences (through a view 1000), which are stored in the user's record as location and schedule attributes, respectively.

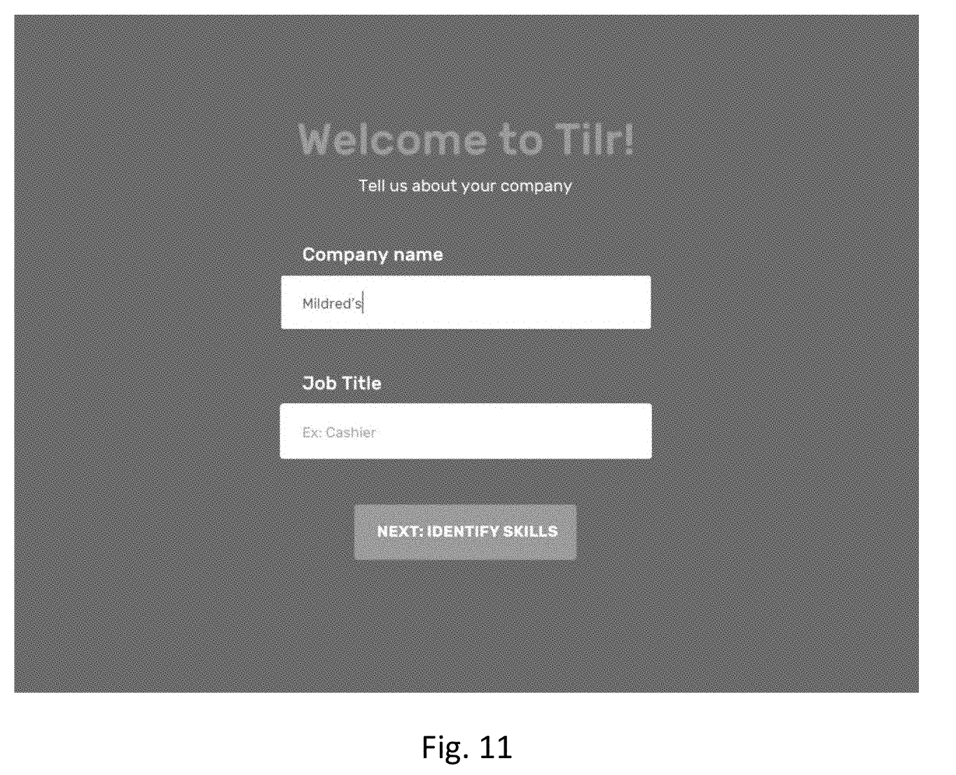

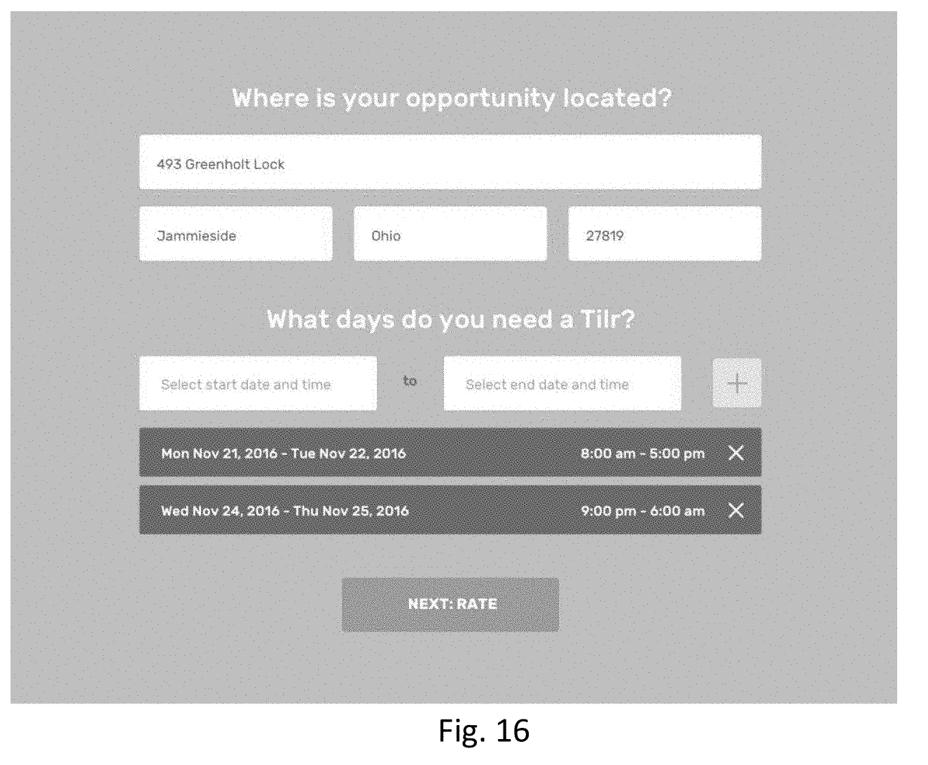

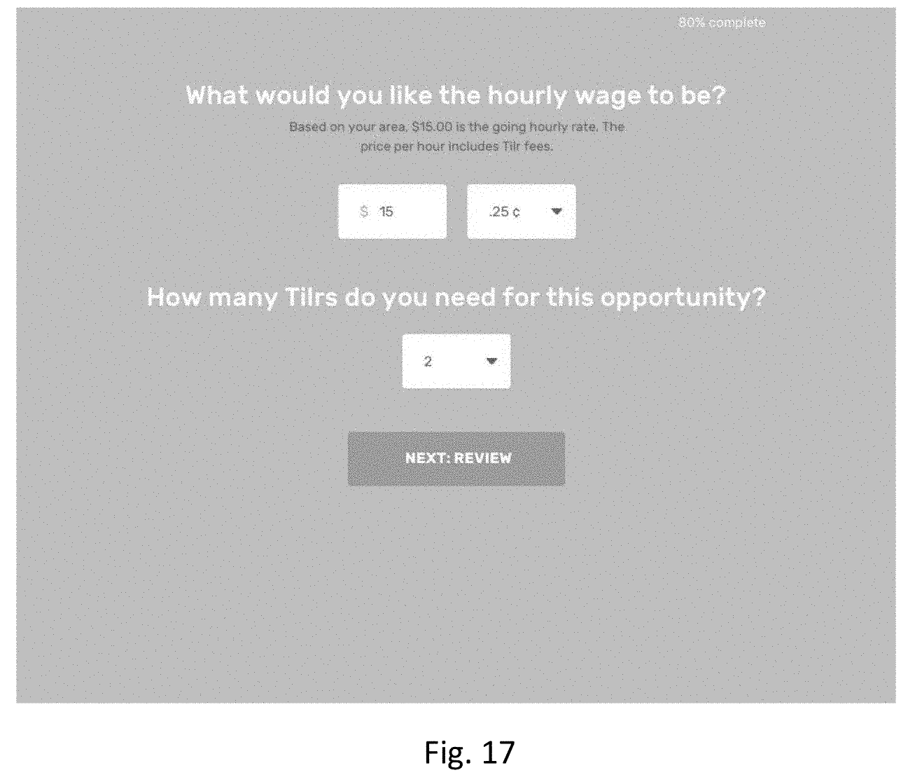

FIGS. 11-17 are screenshots of an example user interface through which an employer can enter information about an opportunity into the system. The information can include the title of the position represented by the opportunity, the location of the opportunity, the schedule for the opportunity, a description of the opportunity, or other information. Through the user interface, the employer can indicate the skills, tools, and/or certifications associated with the opportunity and, in some cases, a level of proficiency for each skill or tool, which are stored in the opportunity record as qualification attributes associated with the opportunity. In the example of FIGS. 11-17, the user interface is the interface of a computing device, such as a desktop or laptop computer. In some examples, the user interface can be the interface of a mobile computing device.

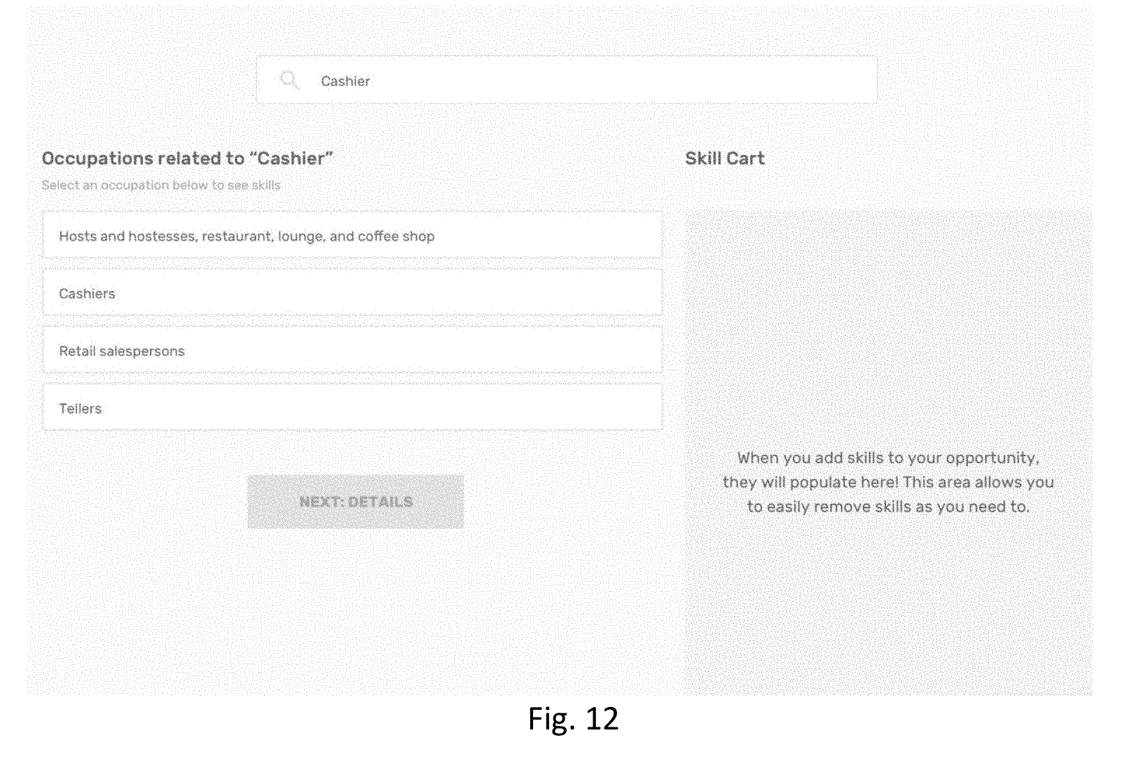

Referring to FIG. 11, in a view 1100, the employer can enter the company name and a title for the position (e.g., Cashier). Referring to FIG. 12, a list of job titles that are similar or related to the title entered by the employer are displayed in a view 1200. For instance, the displayed job titles can be job titles that are similar or related to the entered job title, as determined by the skills engine. The employer can select one or more of the displayed job titles to indicate that the selected job titles are associated with skills, tools, and/or certifications that the employer wants to associate with the opportunity.

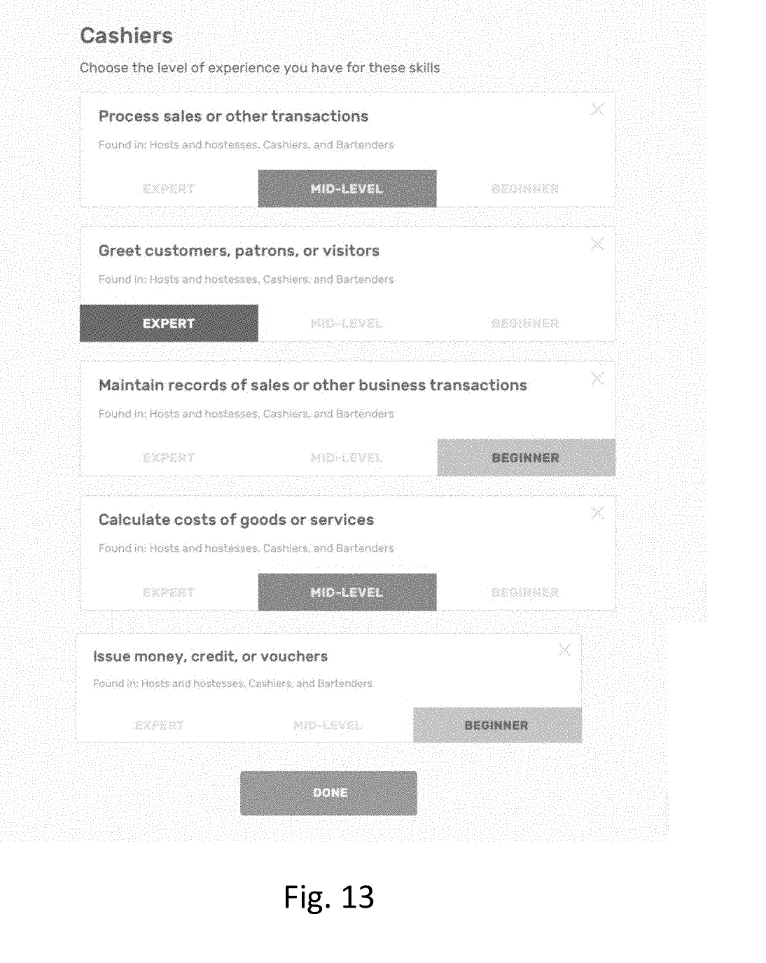

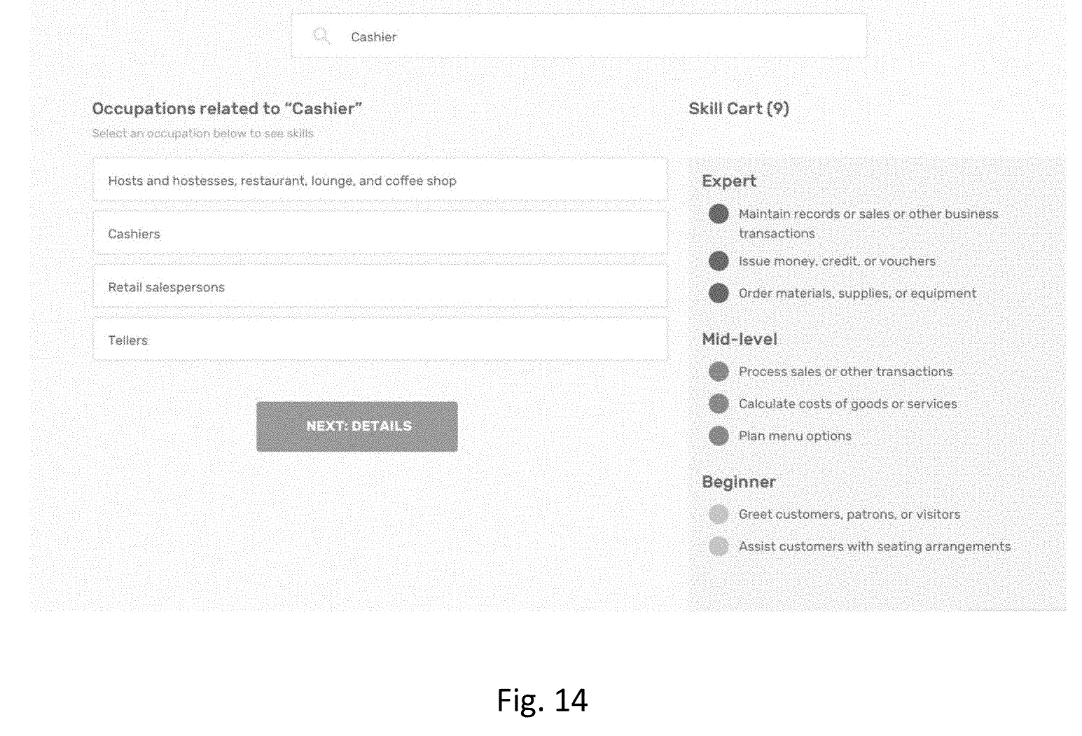

Referring to FIG. 13, in a view 1300, the skills associated with each job title selected by the employer are presented. The employer can select the skills associated with the opportunity and the desired level of proficiency for each skill. Additional views can be displayed to allow the employer to select tools and certifications and desired levels of proficiency. Additional views (not shown) can prompt the employer to select desired certifications and tools proficiencies to be associated with the opportunity. Referring to FIG. 14, a view 1400 displays the skills the employer has indicated and the level of proficiency for each skill. The view 1400 can also display the selected tools and certifications. The information shown in the view 1400 will be used to identify a qualified user to be matched with the opportunity.

In some examples (not shown), the employer can select a predefined opportunity. A predefined opportunity includes a title and associated qualification attributes. Selection of a predefined opportunity simplifies the opportunity creation process in that the employer is freed from having to select the desired qualification attributes for an opportunity. Predefined opportunities can be default job opportunities defined by the system or can be based on opportunities previously created by the employer.

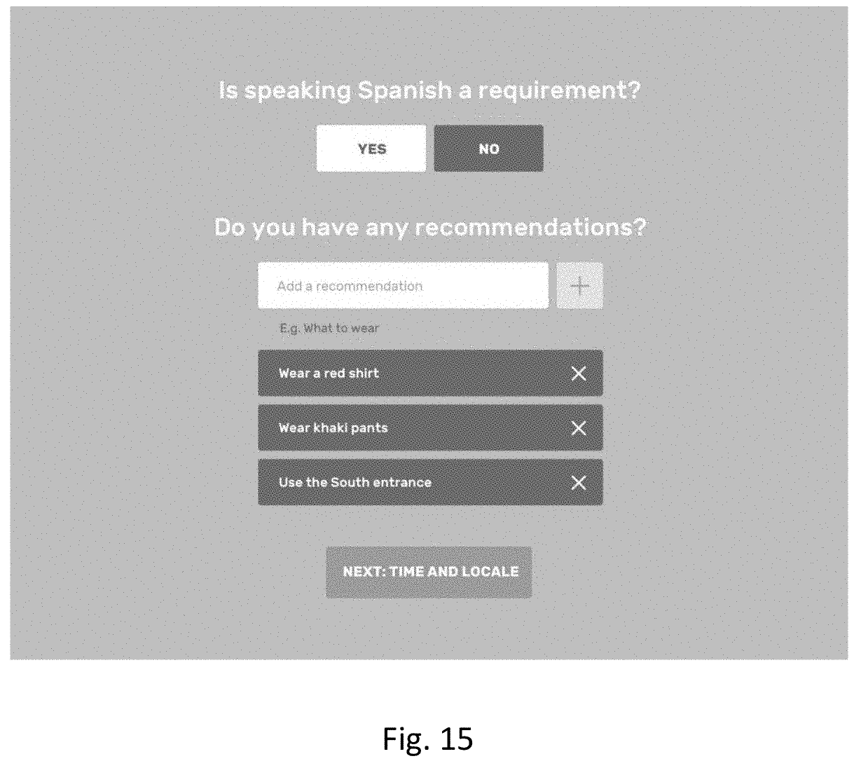

Referring to FIGS. 15-17, the employer can enter additional information about the opportunity. For instance, in a view 1500, the employer can define additional criteria by which a user can be matched with the opportunity, such as language skills. The employer can enter a location and schedule for the opportunity through a view 1600. The employer can enter a general description or instructions for the opportunity, such as a dress code, a description of where the worker is to report, a list of items to bring, or other information. In a view 1700, the employer can define a pay rate for the opportunity and can indicate the number of identical opportunities to create.

For each opportunity defined by an employer, the system queries the user database to identify user records that include qualification attributes matching the qualification attributes associated with the opportunity. For instance, in the example of FIGS. 11-17, the system queries the user database to identify user records including the qualification attributes displayed in the view 1400 and having at least the designated level of proficiency for each qualification attribute. The system can also query the user database based on other criteria, such as based on location or schedule attributes or other attributes associated with the opportunity. The opportunity can then be offered to one or more of the users whose user record was identified as matching the qualification attributes associated with the opportunity (in some cases subject also to other criteria such as location or schedule attributes or other attributes). This approach enables a qualified user to be offered an opportunity for employment in a position for which she is qualified (e.g., a cashier position), even if the user has not previously held a position with the same title or even a position with a related title.

Additional description of approaches to offering the opportunity to the user and enabling the user to accept and complete the opportunity can be found in co-pending U.S. Application Serial No. [Attorney Docket No. 43023-0003001], the contents of which are incorporated here by reference in their entirety.

Other implementations are also within the scope of the following claims.

What is claimed is:

1. A method comprising:
receiving a request associated with a first attribute, the request representative of an opportunity for employment, the attribute representative of a qualification associated with the opportunity for employment;
querying a database to identify a record including a second attribute satisfying the first attribute associated with the request, the second attribute included in the record having been determined based on other information in the record; and
serving, to a computing device operated by a user associated with the identified record, a network resource providing the user with access to information about the request.

2. The method of claim 1, comprising updating a table to include a representation of the identified record.

3. The method of claim 1, comprising updating a data storage to include an identifier of the identified record.

4. The method of claim 1, comprising updating a data storage to include a reference to the identified record.

5. The method of claim 1, in which the second attribute is the same as the first attribute.

6. The method of claim 1, in which the second attribute is different from the first attribute, and in which identifying the record includes querying an attribute database to determine that the second attribute is related to the first attribute.

7. The method of claim 1, in which the request is associated with an opportunity record, in which the first attribute associated with the request is included in the opportunity record.

8. The method of claim 1, in which the first attribute is associated with a first level, and in which querying the database includes querying the database to identify a record in which a second level associated with the second attribute matches the first level associated with the first attribute.

9. The method of claim 1, in which the request is associated with multiple first attributes, each first attribute having a respective weighting factor.

10. The method of claim 9, in which querying the database to identify a record includes identifying a record having second attributes satisfying the first attributes subject to the respective weighting factors of the first attributes.

11. The method of claim 9, comprising determining a score for the record based on the second attributes and respective weighting factors, and in which identifying the record comprising determining that the record has a score higher than a threshold score.

12. The method of claim 9, comprising determining a score for each of multiple records based on the second attributes and respective weighting factors of each of the multiple records, and in which identifying a record comprising identifying the record having the highest score.

13. The method of claim 1, comprising:
querying the database to identify a second record, the second record not having a second attribute that satisfies the first attribute; and
serving, to a computing device operated by a user associated with the identified record, a network resource providing the user with access to information to obtain the second attribute that satisfies the first attribute.

14. The method of claim 1, in which first attribute comprises one or more of a skill attribute, a certification attribute, and a tool attribute.

15. The method of claim 1, the second attribute included in the record having been determined based on a job title included in the record.

16. A non-transitory computer readable medium storing instructions for causing a computing system to:
receive a request associated with one or more attributes, the request representative of an opportunity for employment, each attribute representative of a qualification associated with the opportunity for employment;
query a database to identify a record including the one or more attributes associated with the request, the one or more attributes included in the record having been determined based on other information in the record; and
serve, to a computing device operated by a user associated with the identified record, a network resource providing the user with access to information about the request.

17. The non-transitory computer readable medium of claim 16, the instructions causing the computing system to update a table to include a representation of the identified record.

18. The non-transitory computer readable medium of claim 16, the instructions causing the computing system to update a data storage to include an identifier of the identified record.

19. The non-transitory computer readable medium of claim 16, the instructions causing the computing system to update a data storage to include a reference to the identified record.

20. The non-transitory computer readable medium of claim 16, in which the second attribute is the same as the first attribute.

21. The non-transitory computer readable medium of claim 16, in which the second attribute is different from the first attribute, and in which identifying the record includes querying an attribute database to determine that the second attribute is related to the first attribute.

22. The non-transitory computer readable medium of claim 16, in which the request is associated with an opportunity record, in which the first attribute associated with the request is included in the opportunity record.

23. The non-transitory computer readable medium of claim 16, in which the first attribute is associated with a first level, and in which querying the database includes querying the database to identify a record in which a second level associated with the second attribute matches the first level associated with the first attribute.

24. The non-transitory computer readable medium of claim 16, in which the request is associated with multiple first attributes, each first attribute having a respective weighting factor.

25. The non-transitory computer readable medium of claim 24, in which querying the database to identify a record includes identifying a record having second attributes satisfying the first attributes subject to the respective weighting factors of the first attributes.

26. The non-transitory computer readable medium of claim 24, the instructions causing the computing system to determine a score for the record based on the second attributes and respective weighting factors, and in which identifying the record comprising determining that the record has a score higher than a threshold score.

27. The non-transitory computer readable medium of claim 24, the instructions causing the computing system to determine a score for each of multiple records based on the second attributes and respective weighting factors of each of the multiple records, and in which identifying a record comprising identifying the record having the highest score.

28. The non-transitory computer readable medium of claim 16, the instructions causing the computing system to:
query the database to identify a second record, the second record not having a second attribute that satisfies the first attribute; and
serve, to a computing device operated by a user associated with the identified record, a network resource providing the user with access to information to obtain the second attribute that satisfies the first attribute.

29. The non-transitory computer readable medium of claim 16, in which first attribute comprises one or more of a skill attribute, a certification attribute, and a tool attribute.

30. The non-transitory computer readable medium of claim 16, the second attribute included in the record having been determined based on a job title included in the record.
